(19) United States
(12) Patent Application Publication
(10) Pub. No.: US 2014/0082935 A1
(43) Pub. Date: Mar. 27, 2014

(54) METHOD FOR PASSIVE ALIGNMENT OF OPTICAL COMPONENTS TO A SUBSTRATE

(71) Applicants: VOLEX PLC, London (GB); APPLIED MICRO CIRCUITS CORPORATION, Sunnyvale, CA (US)

(72) Inventors: Ezra Gold, Sunnyvale, CA (US); Subhash Roy, Lexington, MA (US); Igor Zhovnirnovsky, Sunnyvale, CA (US)

(73) Assignees: VOLEX PLC, London (GB); APPLIED MICRO CIRCUITS CORPORATION, Sunnyvale, CA (US)

(21) Appl. No.: 13/657,331

(22) Filed: Oct. 22, 2012

Related U.S. Application Data
(60) Provisional application No. 61/706,658, filed on Sep. 27, 2012.

(51) Int. Cl. G02B 6/42

(52) U.S. Cl. CPC G02B 6/4201
USPC 29/836; 29/739

(57) ABSTRACT

A method for placing components on a substrate, the method comprising determining a reference point of a mechanical holding jig based upon a plurality of mechanical features of the mechanical holding jig and placing the substrate into the jig such that mechanical features on the substrate align with the mechanical features on the mechanical holding jig. A location of the substrate is determined with the reference point of the mechanical holding jig. The method continues by installing a plurality of first components onto the substrate aligned to the mechanical holding jig. The substrate is removed from the mechanical holding jig and a second component is placed onto the substrate to cover the plurality of first components. The second component is placed onto the substrate to align a plurality of references points of the second component to the mechanical features on the substrate. The second component is secured to the substrate.

### TECHNICAL FIELD

The present disclosure relates generally to the field of optical components and more specifically to the field of aligning optical components to a substrate.

### CROSS-REFERENCES TO RELATED APPLICATIONS

This application claims the benefit of Provisional Application No. 61/706,658, filed on Sep. 27, 2012, titled “METHOD FOR PASSIVE ALIGNMENT OF OPTICAL COMPONENTS TO A SUBSTRATE,” by Ezra Gold, which is herein incorporated by reference.

### BACKGROUND

Fiber-optic communications have revolutionized the telecommunications and data communications industries, providing many advantages over traditional electrical transmission via copper wires. At a basic level, fiber-optic transmission begins with the creation of a light signal (a series of light pulses that carry the information from an electrical signal). The light signal may be created with an optic transmitter (e.g., laser emitter). The light signal may then be relayed through a fiber network to a destination point where it is received by an optic receiver (e.g., photo-diode receiver) and converted back into the electrical signal.

For fiber-optics to work correctly, very precise alignment is necessary between optic components. For example, optic transmitters and optic receivers must be very precisely aligned to an optic assembly, such as an optical lens, for connection to a fiber-optic line. Ensuring the alignment of optic components is often a time consuming and tedious process. For example, after optic components (e.g., optic transmitters and/or optic receivers) are mounted on a substrate (following a board layout) and an optic assembly has been installed over the substrate, the optic assembly must be aligned to the optic components installed on the substrate. One way to measure an alignment between an optic assembly and an installed optic component, is to measure signal strength of a light signal transmitted into or out of an optic component, and measuring the received (if the installed optic component measured is a receiver) or transmitted (if the installed optic component measured is a transmitter) power and then slowly scanning the optic assembly around until the signal strength of the received or transmitted signal is optimized. In other words, based upon the signal strength, the position of the optic assembly may be adjusted to optimize the signal strength and thus optimize the position of the optic assembly over the substrate and therefore optimize alignment between the optic assembly and the substrate mounted optic components (e.g., optic transmitters and optic receivers).

One difficultly with this assembly method is that the production of substrates, where the accuracy of the substrate features is sufficient to allow passive alignment between an optic assembly and components on the substrate, is prohibitively expensive. Standard substrate manufacturing methods may only provide +/−50-100 μm alignment accuracy between a pattern used to locate and connect optic components on the substrate and features on the substrate that could be used for passive alignment. However, as an active area of many optic components paired with optic assemblies for networking applications is less than 35 μm (e.g., 5-10 μm) in radius, standard accuracy cannot provide acceptable alignment.

### SUMMARY OF THE INVENTION

Embodiments of this present invention provide solutions to the challenges inherent in aligning optics to a substrate comprising a plurality of optical components. In a method according to one embodiment of the present invention, a method for placing components on a substrate is disclosed. The method comprises determining a reference point of a mechanical holding jig based upon a plurality of mechanical features of the mechanical holding jig and placing the substrate into the jig such that mechanical features on the substrate align with the mechanical features on the mechanical holding jig. A location of the substrate is determined with the reference point of the mechanical holding jig. The method continues by installing a plurality of first components onto the substrate aligned to the mechanical holding jig. The substrate is removed from the mechanical holding jig and a second component is placed onto the substrate to cover the plurality of first components. The second component is placed onto the substrate to align a plurality of references points of the second component to the mechanical features on the substrate. The second component is secured to the substrate.

In an apparatus according to one embodiment of the present invention, a component placement apparatus is disclosed. The component placement apparatus comprises a component placement tool and a mechanical jig assembly. The component placement tool is operable to place a plurality of first components on a substrate. The mechanical jig assembly is operable to hold the substrate during first component placement. The substrate comprises a plurality of mechanical features that are aligned to a plurality of mechanical features on the mechanical jig assembly. The component placement apparatus is operable to determine a physical location of the substrate for first component placement using the mechanical features of the mechanical jig assembly and the mechanical features of the substrate. After first component placement, the substrate is removed from the mechanical jig assembly and a second component is positioned on the substrate by aligning a plurality of mechanical features on the second component to the plurality of mechanical features on the substrate.

In an apparatus according to one embodiment of the present invention, a component placement apparatus is disclosed. The component placement apparatus comprises a component placement tool, a mechanical jig assembly, and a processor and a memory for storing instructions that when executed by the processor perform a component placement method. The component placement method comprises instructions to determine a reference point of the mechanical holding jig based upon a plurality of mechanical features of the mechanical holding jig and instructions to place a substrate into the mechanical holding jig such that mechanical features on the substrate align with the mechanical features on the mechanical holding jig. A location of the substrate is determined with the reference point of the mechanical holding jig. The method further comprises instructions to install a plurality of first components onto the substrate aligned to the mechanical holding jig. After first component placement, the substrate is removed from the mechanical jig assembly and a second component is positioned on the substrate to cover the plurality of first components by aligning a plurality of mechanical features on the second component to the plurality of mechanical features on the substrate.

### BRIEF DESCRIPTION OF THE DRAWINGS

The present invention will be better understood from the following detailed description, taken in conjunction with the accompanying drawing figures in which like reference characters designate like elements and in which:

FIG. 1A illustrates an exemplary simplified overhead diagram of a mechanical holding jig and substrate with matching mechanical features, in accordance with an embodiment of the present invention;

FIG. 1B illustrates an exemplary simplified overhead diagram of a substrate positioned to align to mechanical features of a mechanical holding jig, in accordance with an embodiment of the present invention;

FIG. 1C illustrates an exemplary simplified cross-section along line A-A of FIG. 1B, illustrating the placement of the substrate onto the mechanical features of the mechanical holding jig, in accordance with an embodiment of the present invention;

FIG. 2 illustrates an exemplary simplified overhead diagram of a component placement apparatus and mechanical holding jig, with a substrate positioned to align to mechanical features of the mechanical holding jig, in accordance with an embodiment of the present invention;

FIG. 3A illustrates an exemplary simplified overhead diagram of an optical component ready for alignment with the mechanical features of a substrate, in accordance with an embodiment of the present invention;

FIG. 3B illustrates an exemplary simplified overhead diagram of a substrate aligned and positioned on an optical component, in accordance with an embodiment of the present invention;

FIGS. 4A and 4B illustrate exemplary 3D views of an exemplary optical component with mechanical alignment features, in accordance with an embodiment of the present invention;

FIG. 4C illustrates an exemplary 3D view of an exemplary optical component aligned and positioned with a substrate, in accordance with an embodiment of the present invention;

FIG. 5 illustrates a flow diagram, illustrating the steps to a method for aligning an optics component to components installed onto a substrate in accordance with an embodiment of the present invention; and

FIG. 6 illustrates an exemplary simplified block diagram of a component placement apparatus in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclautre:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Embodiments of this present invention provide solutions to the increasing challenges inherent in installing optical components onto a substrate that must be aligned with an optical assembly that is later mated to the substrate, in such a way that the installed optical components will be precisely aligned to the optical assembly in a reliable, repeatable way. As discussed in detail below, an exemplary alignment method may reduce the cost of manufacturing assemblies that mate optic assemblies to optical components that are mounted onto a substrate by eliminating the need to actively align the optic assembly to the optical components on the substrate. Instead, as discussed in detail below, an exemplary method of assembling the components automatically aligns the optic assembly to the optical components on the substrate through the use of datum or alignment features that may be found on the optical assembly and the substrate, as well as a mechanical jig that is used during the optical component placement.

An exemplary method of assembly may allow higher accuracy alignment between the installed electro-optical components (e.g., optic transmitters and optic receivers) and the substrate while maintaining an alignment between an optics assembly and the substrate. Datum or alignment features are added to the substrate on which the electro-optical components will be placed. In one exemplary embodiment, a datum or alignment feature may be a physical point (e.g. a flat or curved portion or a pin that contacts another surface) that is used as a reference point. This set of datums or alignment features are constructed in such a way that both a machine placing the electro-optical components on the substrate and the optics assembly can reference the datums or alignment features in the same way. References to the datums or alignment features may be optical or physical, but the same features should be referenced for both placement of electro-optical components and assembly with the optics assembly.

A pattern on the substrate for locating critical electro-optical components may be made with larger connection and landing areas so that the electro-optical components can be placed in the optimal locations as determined by the datums or alignment features while still allowing optimal placement and connection to the substrate.

As illustrated in the figures discussed herein, a fiber-optic assembly may be assembled in the following manner. A substrate or circuit board (hereafter referred to as a substrate) may be set in a component placement machine, where its position in the component placement machine is defined using the datums or alignment surfaces as reference locations. There are many ways that these reference locations may be defined and determined. For example, in one embodiment, the reference locations may be determined using optical location features of the placement machine to directly detect the datums or alignment surfaces and use these detected locations to define a location of the substrate in the placement machine. In one embodiment, the reference locations may be determined by using a mechanical jig that contacts the datums or alignment surfaces to define the location of the substrate in the placement machine. In one embodiment, the reference locations may be determined by using a mechanical jig that has mechanical alignment features on the jig. The jig mechanically contacts the datums or alignment features on the substrate to locate the substrate precisely in the jig. The alignment features on the jig are then detected using mechanical contact within the placement machine. This can allow multiple substrates to be located at one time within the placement machine. In another embodiment, the reference locations may be determined by using a mechanical jig comprising optical alignment features. The jig mechanically contacts the datums or alignment features on the substrate to locate the substrate precisely in the jig. The alignment features on the jig are then detected using optical methods by the placement machine. This may resolve substrate location with higher accuracy if the datums or alignment features on the substrate are difficult to detect accurately using optical methods or to locate multiple substrates at one time. These methods discussed above are exemplary in nature and are not meant to be limiting, as there are other methods for determining the reference locations that may also be utilized and are considered to be within the scope of this disclosure.

Using the location of the substrate determined by one of the methods described above, electro-optical components may be placed onto the substrate at optimum locations with reference to the datums or alignment features on the substrate. In other words, so long as the datums or alignment features on the substrate match up with the corresponding datums or alignment features on the jig, a reference point for the jig may be used for precise placement of optical components onto the substrate.

In one exemplary embodiment, the electro-optical component and connection pads are large enough to accommodate misalignment between the pattern on the substrate and the substrate datums or alignment features, variations in electro-optical component placement accuracy, variations in component size, and variations in component connection accuracy. Once the electro-optical components are placed, the electro-optical components may be mechanically and electrically connected to the substrate preserving the placement position. The optics assembly may now be mated to the substrate using the same datums or alignment features used during the above described electro-optical component placement process. Alignment to the substrate datums or alignment features may be mechanical, by direct contact with the datums or alignment features, or alignment may be optical using a visual or machine vision solution to achieve alignment. Once the optics assembly is placed it is connected to the substrate preserving the placement position. Mechanical connection between the optics assembly and the substrate may be via bonding or a mechanical fastening.

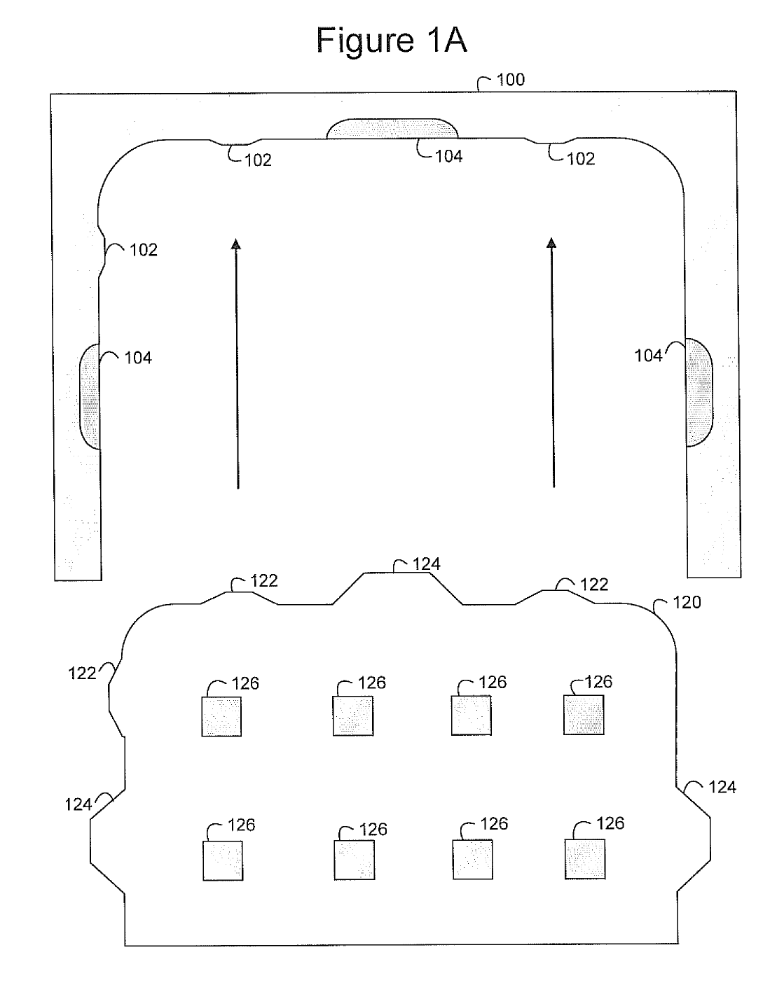

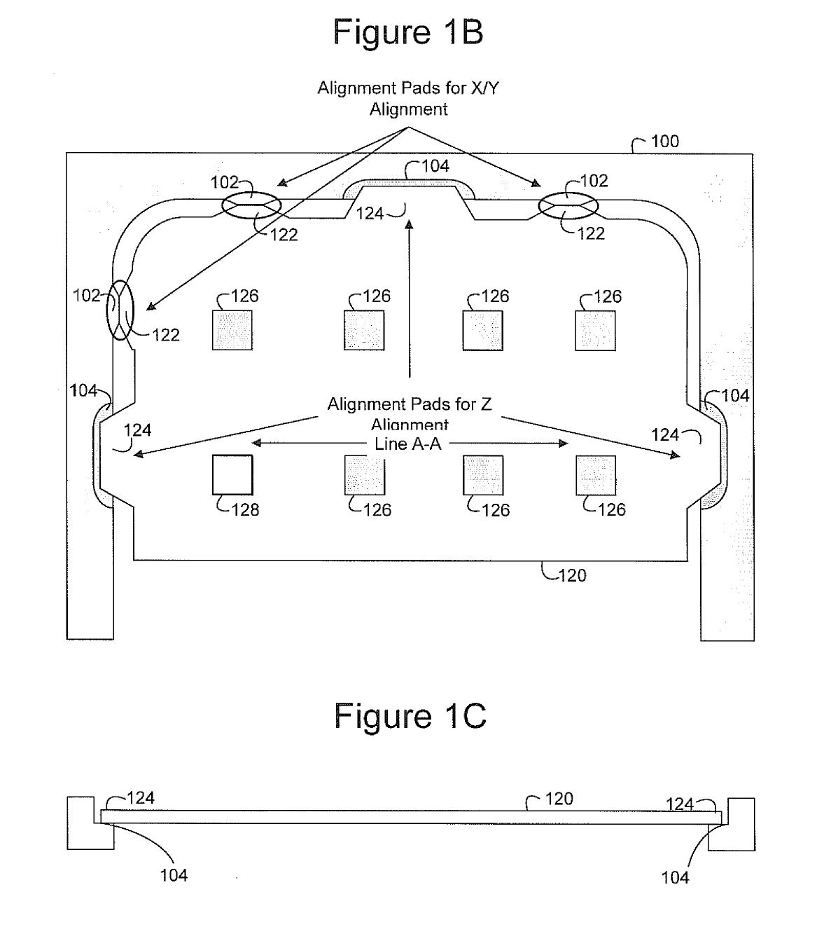

FIG. 1A illustrates an exemplary mechanical holding jig 100 (may also be referred to as a mechanical jig assembly) and an exemplary substrate 120 aligned for placement in the mechanical holding jig 100. The features, sizes, and arrangements illustrated in FIG. 1A (and the other figures discussed in detail herein) are exaggerated for the sake of clarity and are not to scale. FIG. 1A illustrates a top-down view of the mechanical holding jig 100 and the substrate 120. As also illustrated in FIG. 1A, the side of the substrate 120 visible is a top side with component pads 126 for placement of optical components. As discussed herein, the optical components that may be placed on the component pads 126 comprise optic transmitters and optic receivers. As also illustrated in FIG. 1A, the mechanical holding jig 100 comprises three datums or mechanical features 102 that when aligned with matching datums or mechanical features 122 in the substrate 120 will accurately position and hold the substrate 120 in the X and Y planes as well as restricting rotation on the Z-axis. Three additional datums or mechanical features 104 may be formed as inverse knock-out ledges 104 on the mechanical holding jig 100, that when aligned with matching Z-axis defining datums or mechanical features 124 on the substrate 120 will accurately position and hold the substrate 120 in the Z plane as well as restricting rotation in the remaining two axis, X-axis and Y-axis.

FIG. 1B illustrates an exemplary substrate 120 positioned in an exemplary mechanical holding jig 100. As illustrated in FIG. 1B, the datums or mechanical features 102 of the mechanical holding jig 100 line up with the corresponding datums or mechanical features 122 of the substrate 120 when the substrate 120 is properly placed into the mechanical holding jig 100. As discussed herein, the substrate 120 will be properly placed within the mechanical holding jig 100 when it is pushed into the top left-hand side of the mechanical holding jig 100. As also illustrated in FIG. 1B, when the substrate 120 is properly placed in the mechanical holding jig 100, the Z-axis defining datums or mechanical features 124 of the substrate will be resting on the ledges 104 formed in mechanical holding jig 100. As also illustrated in FIG. 1B, the paired datums or mechanical features 102/122 provide X and Y axis alignment, while the paired datums or mechanical features 104/124 provide Z axis alignment.

As also illustrated in FIG. 1B, the sets of datums or mechanical features 102, 122 may be in groups of three each. As illustrated in FIG. 1B and discussed below, by placing three datums or mechanical features 102 on the mechanical holding jig 100 for mating with three datums or mechanical features 122 in the substrate 120, the substrate 120 may be fitted to the mechanical holding jig 100 in a desired way. For example, once placed into the mechanical holding jig 100 and pushed into the upper left-hand corner so that all three pairs of datums or mechanical features 102/122 properly mate, as well as the substrate 120 resting by corresponding Z-axis defining datums or mechanical features 124 on the three cutouts 104, the substrate 120 may be locked in all six possible degrees of freedom (that is, movement in the X, Y, and Z planes, and rotations around the X, Y, and Z axes).

As illustrated in FIG. 1B, there will be two datums or mechanical features 102 on one side of the mechanical holding jig 100 and a single datum or mechanical feature 102 on the adjoining left side of the mechanical holding jig 100. Without datums or mechanical features 102 placed in such an orientation (two on one surface and one on an adjoining surface the location of the substrate 120 may be indeterminate. For example, if two mechanical features are placed on either side of the mechanical holding jig, if the substrate 120 was wider or narrower, there would be no accurate way to determine whether the substrate 120 needed to be pushed in one direction or another in the X-plane or Y-plane. Further, the substrate 120 would be susceptible to rotation in the X-plane along the X-axis.

In one exemplary embodiment, after the substrate 120 has been positioned into the mechanical holding jig 100 such that the corresponding datums or mechanical features 102/122, 104/124 are properly aligned, the substrate may be held into place in the mechanical holding jig 100 with the use of a vacuum or a holding fixture, or such other holding arrangement or holding method that retains the alignment of the substrate 120 in the mechanical holding jig 100. As discussed herein, once the substrate 100 has been aligned to the mechanical holding jig 100, a component placement machine that has a reference point established for the mechanical holding jig 100 and a component arrangement as established from one or more alignment fiducials, the component placement machine will be able to place one or more optical components 128 on the pads 126 on the substrate 120 while only referencing the mechanical holding jig 100.

FIG. 1C illustrates a cross-sectional view of the mechanical holding jig 100 and substrate 120 along line A-A illustrated in FIG. 1B. As illustrated in FIG. 1C, when the substrate 120 is properly placed in the mechanical holding jig 100, the Z-axis defining datums or mechanical features 124 of the substrate will be resting on ledges 104 formed into the mechanical holding jig 100.

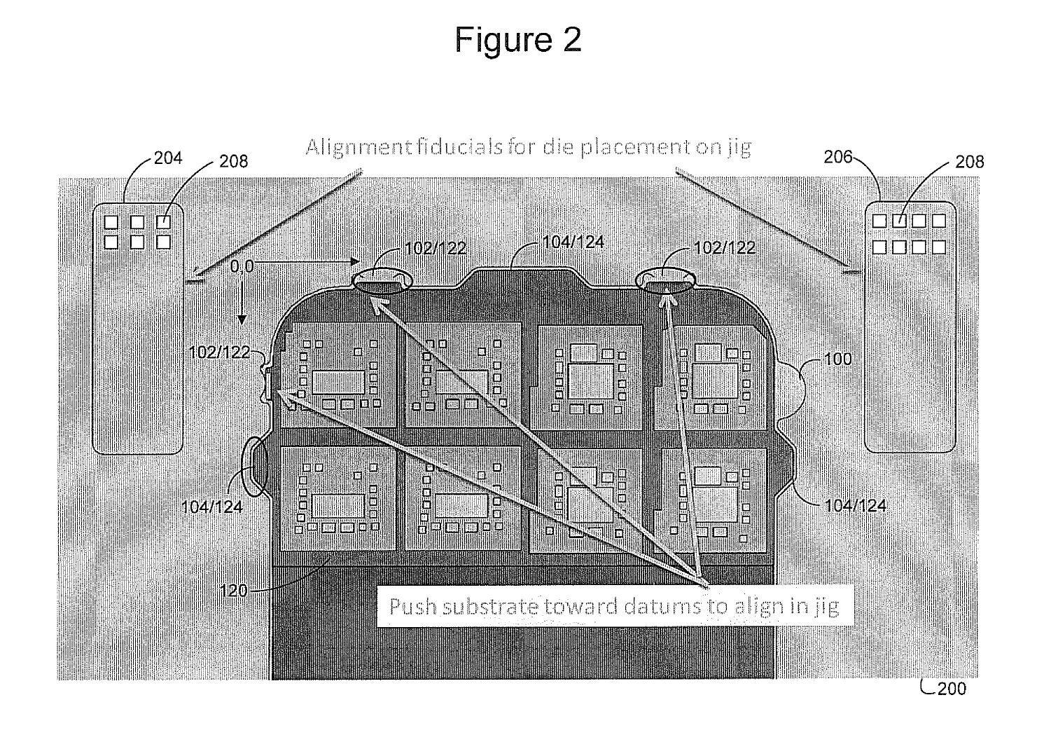

FIG. 2 illustrates an exemplary component placement tool 200 comprising at least one mechanical holding jig 100 for holding a substrate 120 and at least one alignment fiducial 204, 206. As illustrated in FIGS. 1B, 1C, and 2, the datums or mechanical features 122, 124 of the substrate 120 are aligned with corresponding datums or mechanical features 102, 104 of the mechanical holding jig 100. As discussed herein, a component placement machine may use one or more alignment fiducials 204, 206 to determine a desired layout for the optical components 128 to be placed on the pads 126. As discussed herein, alignment fiducials 204, 206 are provided as a visual reference so that a component placement system is able to read the location of reference components 208 on the alignment fiducials 204, 206 to provide a coordinate system for the placement of the optical components 128 on a substrate 120 in the mechanical holding jig 100. In other words, the component placement machine may read the locations of the components 208 in the alignment fiducials 204, 206 to determine the coordinates for the placement of optical components 128 on the substrate 120. As also illustrated in FIG. 2, there may be different alignment coordinates depending on the desired placement of the optical components 128 on the substrate 120, therefore, the mechanical holding jig 100 may provide a plurality of alignment fiducials 204, 206 to be used, the selection of which is based upon a desired component placement scheme.

In one exemplary embodiment, the component placement machine 200 determines a reference point (e.g. 0,0) for the mechanical placement jig 100 and determines the placement of the components 128 based upon the coordinate system from the alignment fiducials 204, 206 and the reference point. In one exemplary embodiment, the reference point may be a point of origin or a 0, 0 location in X/Y axes. In other words, after determining a reference point for the mechanical holding jig 100, the component placement machine places the optical components 128 onto a substrate 120 without referencing a location of the substrate 120.

In one embodiment, a component placement machine may use an optical position tool to determine a location of each datum 122, 124 directly off the substrate 120 and to then install optical components 128 onto the substrate 120 based upon an optically determined alignment of the component placement machine to the substrate 120. In other words, where the datums 122, 124 of the substrate 120 are directly determined (e.g., optically determined), the optical components 128 are placed onto the substrate 120 without referencing a location of a mechanical holding jig 100 that may still be used to hold the substrate 120 steady and stable during component 128 placement. In one exemplary embodiment, only the X-axis and Y-axis and the rotation of the plane of the substrate 120 are tightly constrained. The other degrees of freedom, Z-axis and the other rotations are not as critical to optimal optical component 128 placement.

After the desired optical components 128 are placed onto the substrate 120, the substrate 120 may be removed from the mechanical holding jig 100. In one exemplary embodiment, eight optical components 128 may be placed onto a substrate 120. In another embodiment, a variety of different quantities of optical components 128 may be placed onto a substrate 120, for example, 2-60 different optical components 128 may be placed on the substrate 120. In one embodiment, each optical transmitter component is paired with an optical receiver component. In one embodiment, an asymmetrical quantity of optical components 128 is installed on a substrate 120. For example, from a total of eight optical components 128 installed on a substrate 120, two may be optical transmitters, while the remaining six are optical receivers.

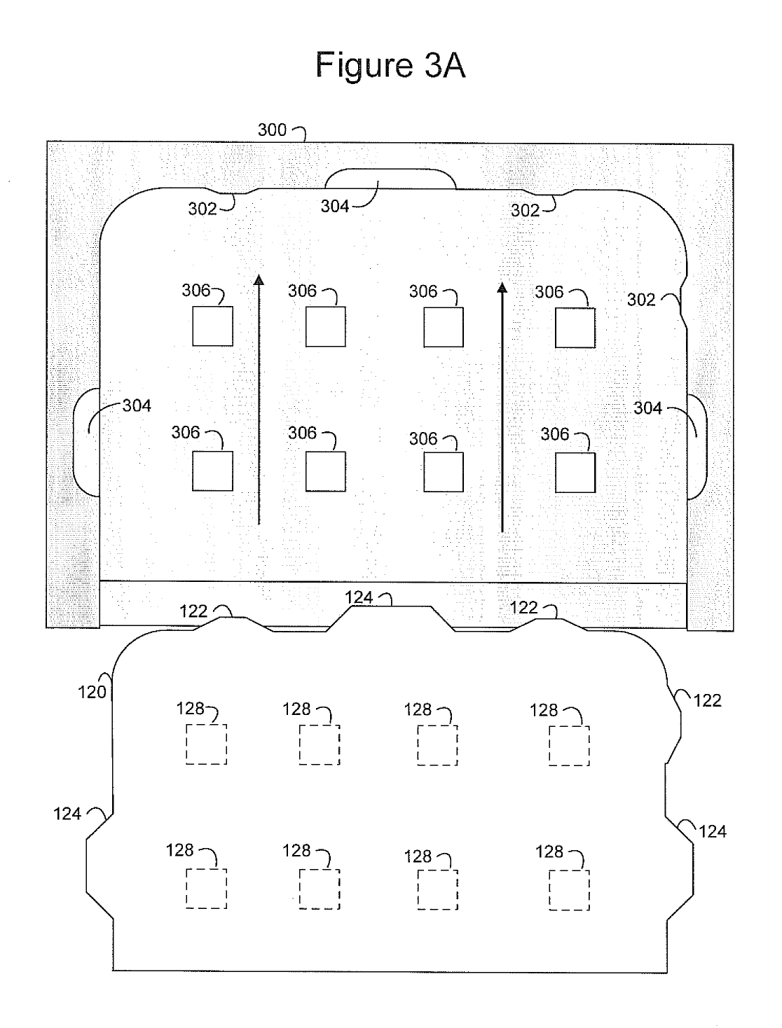

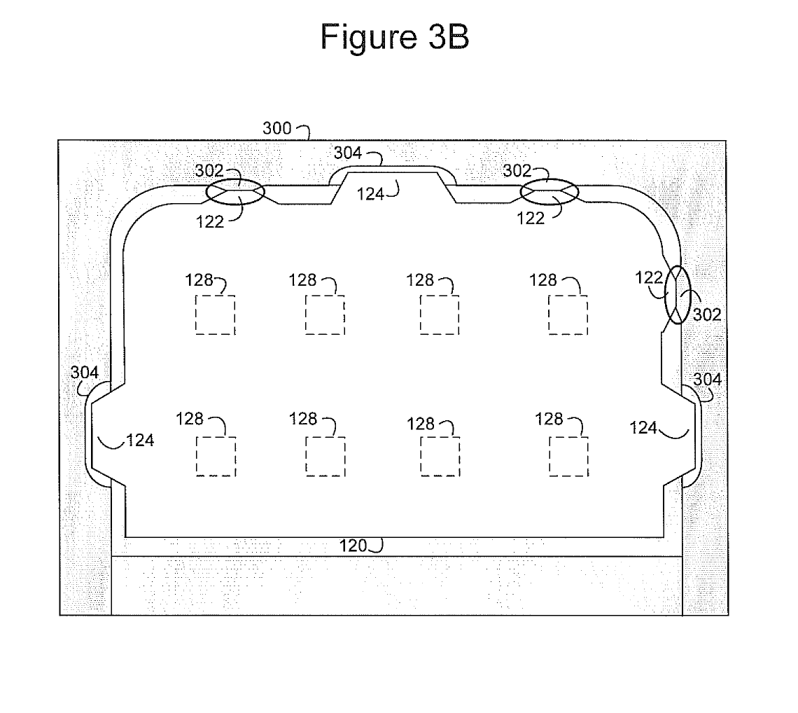

FIG. 3A illustrates an exemplary optics assembly 300 and an exemplary substrate 120 after the placement of optical components 128 and the removal of the substrate 120 from a mechanical holding jig 100. As illustrated in FIG. 3A, the substrate 120 is rotated 180 degrees in orientation from previous figures so that a back side of the substrate 120 is visible in FIG. 3A. As also illustrated in FIG. 3A, the optics assembly 300 comprises a series of datums or mechanical features 302, 304 that are identical to the datums or mechanical features 102, 104 of the mechanical holding jig 100 illustrated in FIGS. 1A, 1B, and 1C. FIG. 3A also illustrates that the optics assembly 300 may comprise a plurality of optics lenses 306 or other such fiber optics handling devices. As illustrated in FIG. 3A, the optics lenses 306 may be arranged in a same orientation as the optical components 128 installed on the opposite side of the substrate 120. As illustrated in FIG. 3A, the optical components 128 will each individually align with a matching optical lens 306 when the substrate 120 is aligned with and mated to the optics assembly 300. As illustrated in FIG. 3A, the optics assembly 300 comprises lenses 306 that will each align to a corresponding optical component 128 installed on the substrate 120. The lenses of the optics assembly 300 may be passively aligned to the corresponding optical components 128 installed on the substrate 120 when the optics assembly 300 is mated to the substrate 120.

FIG. 3B illustrates a substrate 120 mated to an optics assembly 300. As illustrated in FIG. 3B, the datums or mechanical features 122, 124 of the substrate are aligned with corresponding datums or mechanical features 302, 304 of the optics assembly 300. As discussed herein, the optical lenses 306 of the optics assembly 300 are arranged on the optics assembly 300 in such an orientation and configuration that when the datums or mechanical features 122, 124 of the substrate 120 are aligned with corresponding datums or mechanical features 302, 304 of the optics assembly 300, each individual lens 306 is passively aligned with a corresponding optical component 128 installed on the substrate 120. Once the optics assembly 300 has been aligned and mated with the substrate 120, the optics assembly 300 may be connected to the substrate 120 to preserve the placement position. In one exemplary embodiment, mechanical connection between the optics assembly 300 and the substrate 120 may be via bonding agent or a mechanical fastening. For example, a bonding agent may be applied between corresponding datums or mechanical features 122, 302; 124,304 of the substrate 120 and optics assembly 300, respectively.

Any error between reference points and datums or mechanical features and any patterning on the substrate 120 would be cancelled out as the same error would appear in both the optical component 128 placement and the mating of the optics assembly 300 to the substrate 120. The optics assembly 300 and the optical components 128 placed on the substrate 120 are aligned to each other; therefore, they would have the same error, which would be cancelled out with regards to the alignment of the lenses 306 of the optics assembly 300 and the optical components 128.

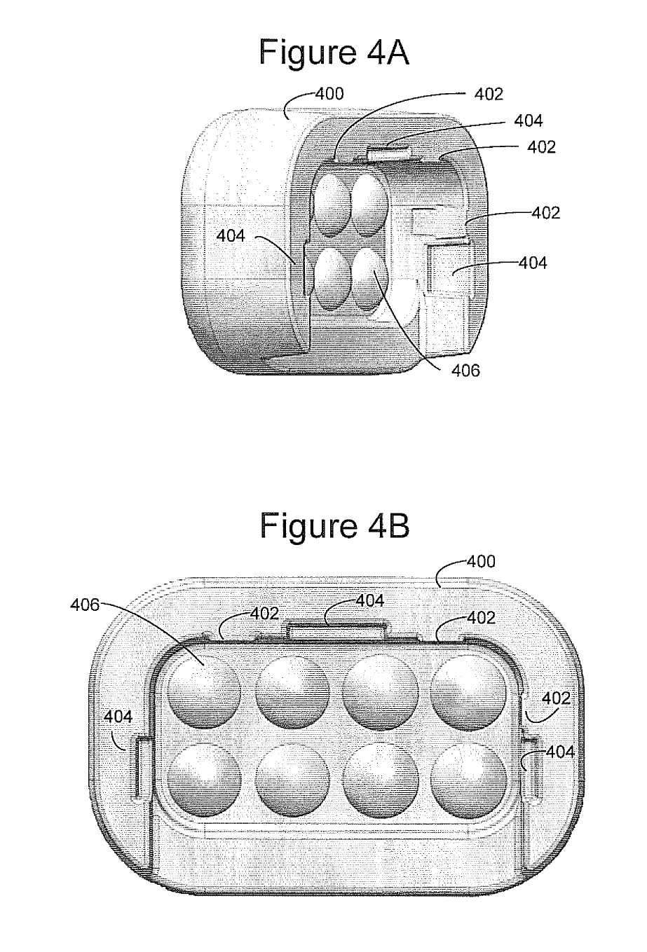

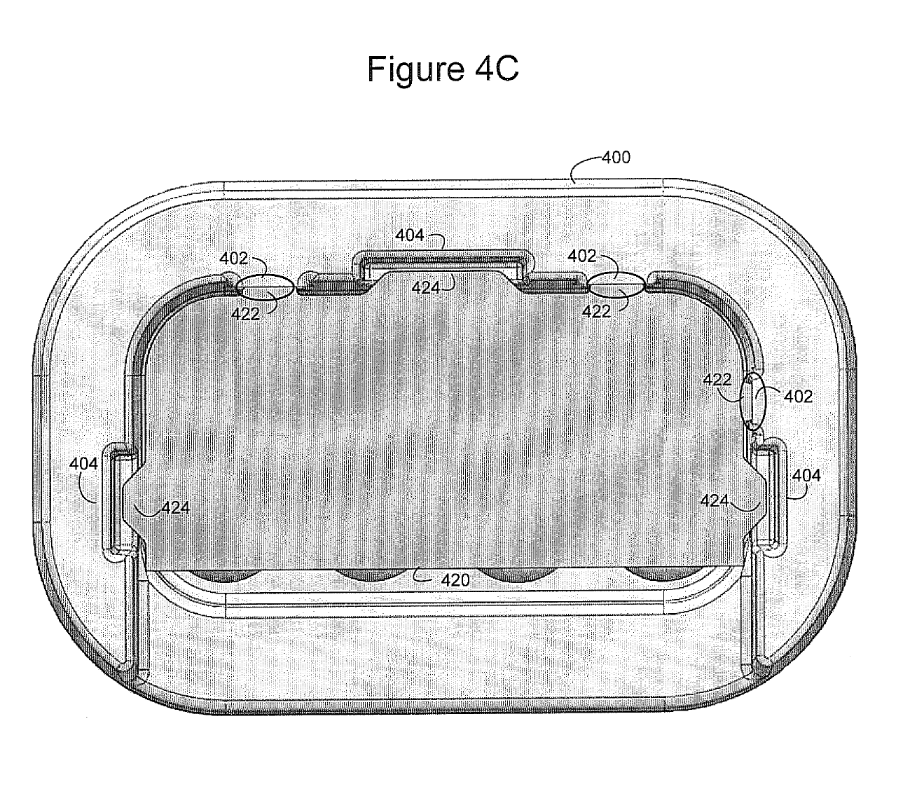

FIGS. 4A and 4B illustrate exemplary three-dimensional views of an optics assembly 400 in accordance with an embodiment of the present disclosure. As illustrated in FIGS. 4A and 4B, the optics assembly 400 comprises a plurality of optical lenses 406, each orientated to pair up with a matching optical component 128 installed on a substrate 120. As illustrated in FIGS. 4A and 4B, the optics assembly 400 comprises a plurality of datums or mechanical features 402 that comprise extending knock-out features that datums or mechanical features 122 of a mating substrate 120 would contact when the substrate 120 is properly aligned and mated to the optics assembly 400. FIGS. 4A and 4B also illustrate that the inverse knock-out ledges 404 created for the remaining datums or mechanical features 404 of the optics component 400 provide ledges for the remaining datums or mechanical features 124 of the substrate 124 to rest upon. In one exemplary embodiment, a three-dimensional view of the datums or mechanical features 102, 104 of a mechanical holding jig 100 would be identical in position, size, shape, and orientation as the datums or mechanical features 402, 404 of the optics assembly 400.

FIG. 4C illustrates an exemplary substrate 420 aligned and mated to an exemplary optics assembly 400. As illustrated in FIG. 4C, the substrate 420 is rotated so that the back side of the substrate 420 is visible, with the optical components 128 installed on the substrate 420 hidden from view. As also illustrated in FIG. 4C, and discussed herein, datums or mechanical features 422, 424 of a substrate 420 are aligned with and in contact with corresponding datums or mechanical features 402, 404 of the optics assembly 400. As discussed herein, once the optics assembly 400 has been aligned and mated with the substrate 420, the optics assembly 400 may be mechanically connected to the substrate 420 to preserve a placement position. Mechanical connection between the optics assembly 400 and the substrate 420 may be via bonding agent or a mechanical fastening, as described herein.

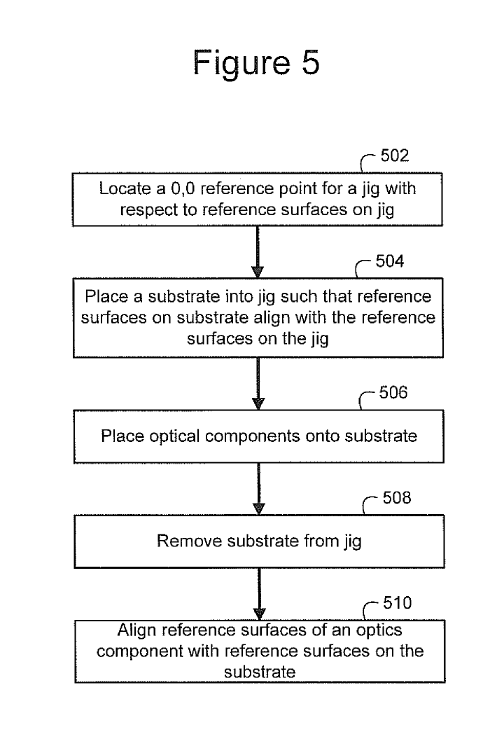

FIG. 5 illustrates stages or steps to a manufacturing process for passively aligning a plurality of optical lenses 306 of an optics assembly 300 to a plurality of optical components 128 installed on a substrate 120 when the optics assembly 300 is aligned and mated to the substrate 120 after installation of the optical components 128 on the substrate 120. In step 502 of FIG. 5, a reference point, such as a location 0, 0, is determined for a mechanical holding jig 100 by a component placement machine. The reference point for the mechanical holding jig 100 is made with respect to reference surfaces on the mechanical holding jig 100. In one exemplary embodiment, the reference surfaces are datums or mechanical features 102, 104 of the mechanical holding jig 100, as discussed herein.

In step 504 of FIG. 5 a substrate 120 is placed into the mechanical jig 100 such that reference surfaces on the substrate 120 align with the reference surfaces on the mechanical holding jig 100. In one exemplary embodiment, the reference surfaces are datums or mechanical features 122, 124 of the substrate 120, as discussed herein. In one exemplary embodiment, the substrate 120 is orientated and positioned so that it makes contact with at least two side surfaces of the mechanical holding jig 100. In one exemplary embodiment, the substrate 120 makes contact with a top surface and an upper left side surface of the mechanical holding jig 100.

In step 506 of FIG. 5, optical components 128 are placed onto the substrate 120. In one exemplary embodiment a plurality of optical components 128 are arranged in a pattern according to a coordinate system as determined by the component placement machine from at least one alignment fiducial 204, 206 that is provided as a visual reference of the locations of the reference components 208 on the alignment fiducials 204, 206. As discussed herein, the component placement machine is operable to place the components 128 in the desired configuration based upon the determined reference point on the mechanical holding jig 100 and the determined coordinate system for the substrate 120. As discussed herein, the optical components 128, after placement on the substrate 120, are mechanically connected to the substrate 120 to retain their placement position. The mechanical connection may be made via bonding agent or mechanical fastening.

In step 508 of FIG. 5, the substrate 120 with at least one optical component 128 placed upon it, is removed from the mechanical holding jig 100. In step 510 of FIG. 5, an optics assembly 300 is aligned and mated with the substrate 120. In one exemplary embodiment, in aligning the optics component 300 to the substrate 120, a plurality of datums or mechanical features (reference surfaces) 302, 304 of the optics assembly 300 are aligned with a plurality of datums or mechanical features (reference surfaces) 122, 124 of the substrate 120. As also discussed herein, when the optics assembly 300, comprising a plurality of optics lenses 306, is aligned to the substrate 120, the optics lenses 306 are passively aligned to the optical components 128 installed on the substrate 120.

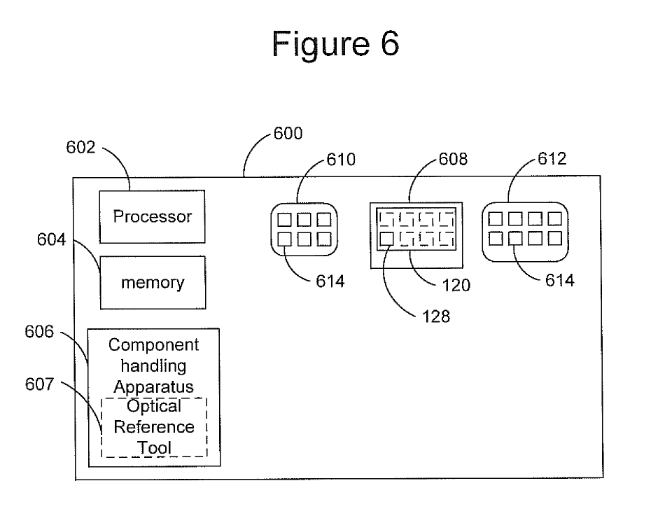

FIG. 6 illustrates an exemplary component placement apparatus 600 comprising a processor 602, a memory 604, a component handling apparatus 606, at least one mechanical holding jig 608, and at least one alignment fiducial 610, 612. In one exemplary embodiment, the processor 602 is operable to access the memory 604 to access computer instructions that when executed by the processor 602 perform steps to a method for determining a reference point(s) on the one or more mechanical holding jigs 608, and then determining a coordinate system for placement of one or more optical components 128 by the component handling apparatus 606 on a substrate 120 that is aligned to and affixed to the mechanical holding jig 608. As discussed herein, the coordinate system may be determined by accessing the at least one alignment fiducial 610, 612 with the component handling apparatus 606 and reading a placement of components 614 on the selected alignment fiducial 610, 612 to determine the desired coordinate system. Therefore, the exemplary component placement apparatus 600 is operable to accurately and repeatedly place components 128 onto a substrate 120 without reference to a physical location of the substrate 120 when the component placement apparatus 600 has determined a reference point for the mechanical holding jig 608 and a coordinate system for placement of the desired optical components 128.

In another exemplary embodiment, the component handling apparatus 600 comprises an optical reference tool 607 that is operable to determine a location of the substrate 120 based upon a visual inspection of the substrate 120 by the optical reference tool 607. The visual inspection of the substrate 120 identifies the locations of the datums or mechanical features 122, 124 of the substrate, as discussed and illustrated herein. In this embodiment, the component handling apparatus 606 would place the components 128 on the substrate 120 without determining a reference point of the mechanical holding jig 608, instead, the component handling apparatus 606 determines a reference point of the substrate 120 itself after locating the datums or mechanical features 122, 124 of the substrate 120 with the optical reference tool 607.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for placing components on a substrate, the method comprising:
determining a reference point of a mechanical holding jig based upon a plurality of mechanical features of the mechanical holding jig;
placing the substrate into the jig such that mechanical features on the substrate align with the mechanical features on the mechanical holding jig, wherein a location of the substrate is determined with the reference point of the mechanical holding jig;
installing a plurality of first components onto the substrate aligned to the mechanical holding jig;
removing the substrate from the mechanical holding jig;
placing a second component onto the substrate to cover the plurality of first components, wherein placing the second component onto the substrate aligns a plurality of mechanical features of the second component to the mechanical features on the substrate; and
securing the second component to the substrate.

2. The method of claim 1, wherein the reference point is determined through mechanical registration of the plurality of mechanical features of the mechanical holding jig.

3. The method of claim 1, wherein the reference point is determined through optical definition of the mechanical features of the mechanical holding jig.

4. The method of claim 1, wherein mechanical features comprise at least one of datum points and physical reference features.

5. The method of claim 1, wherein the first and second components are optical components.

6. The method of claim 1, wherein the first components comprise at least one of optical receivers and optical transmitters.

7. The method of claim 1, wherein the second component comprises an optical lens assembly.

8. A component placement apparatus comprising:
a component placement tool operable to place a plurality of first components on a substrate;
a mechanical jig assembly operable to hold the substrate during first component placement, wherein the substrate comprises a plurality of mechanical features that are aligned to a plurality of mechanical features on the mechanical jig assembly, wherein the component placement apparatus is operable to determine a physical location of the substrate for first component placement using the mechanical features of the mechanical jig assembly and the mechanical features of the substrate, and wherein after first component placement, the substrate is removed from the mechanical jig assembly and the substrate is operable to be positioned on a second component to cover the plurality of first components by aligning a plurality of mechanical features on the second component to the plurality of mechanical features on the substrate.

9. The component placement apparatus of claim 8, wherein the component placement apparatus is further operable to determine the physical location of the substrate in the mechanical jig assembly by mechanical registration of the plurality of mechanical features of the mechanical holding jig.

10. The component placement apparatus of claim 8, wherein the component placement apparatus is further operable to determine the physical location of the substrate in the mechanical jig assembly by optical definition of the mechanical features of the mechanical holding jig.

11. The component placement apparatus of claim 8, wherein mechanical features comprise at least one of datum points and physical reference features.

12. The component placement apparatus of claim 8, wherein the first and second components are optical components.

13. The component placement apparatus of claim 8, wherein the first components comprise at least one of optical receivers and optical transmitters.

14. The component placement apparatus of claim 8, wherein the second component comprises an optical lens assembly.

15. A component placement apparatus comprising:
a component placement tool;
a mechanical jig assembly; and
a processor and a memory for storing instructions that when executed by the processor perform a component placement method comprising:
instructions to determine a reference point of the mechanical holding jig based upon a plurality of mechanical features of the mechanical holding jig;
instructions to place a substrate into the mechanical holding jig such that mechanical features on the substrate align with the mechanical features on the mechanical holding jig, wherein a location of the substrate is determined with the reference point of the mechanical holding jig; and
instructions to install a plurality of first components onto the substrate aligned to the mechanical holding jig, and wherein after first component placement and removing the substrate from the mechanical jig assembly, the substrate is operable to be positioned on a second component to cover the plurality of first components by aligning a plurality of mechanical features on the second component to the plurality of mechanical features on the substrate.

16. The component placement apparatus of claim 15, wherein the reference point is determined through mechanical registration of the plurality of mechanical features of the mechanical holding jig.

17. The component placement apparatus of claim 15, wherein the reference point is determined through optical definition of the mechanical features of the mechanical holding jig.

18. The component placement apparatus of claim 15, wherein mechanical features comprise at least one of datum points and physical reference features.

19. The component placement apparatus of claim 15, wherein the first and second components are optical components.

20. The component placement apparatus of claim 15, wherein the first components comprise at least one of optical receivers and optical transmitters.

21. The component placement apparatus of claim 15, wherein the second component comprises an optical lens assembly.
